(19) United States
(12) Patent Application Publication
(10) Pub. No.: US 2011/0252897 A1
(43) Pub. Date: Oct. 20, 2011

(54) Versatile remote slit impact air sampler controller system

(76) Inventors: Erik Axel Swenson, Longmont, CO (US); Donald Jason Dennis, Frederick, CO (US)

(21) Appl. No.: 13/066,631

(22) Filed: Apr. 20, 2011

Related U.S. Application Data
(60) Provisional application No. 61/342,845, filed on Apr. 20, 2010.

(51) Int. Cl. G01N 1/00

(52) U.S. Cl. 73/863

(57) ABSTRACT

A versatile remote slit impact air sampler controller system for the enhanced operative control of known slit impact air samplers, as well as other remote sampling devices that would benefit from an enhanced air-sampling platform. The described device will substantially enhance the functionality, versatility, and capabilities for the operation of the inventors remote slit sampling devices, adding substantial advances in data capture, maintenance, and output capabilities, user interface functionality, sampling period programmability and versatility, sample flow rate selectivity, air sampler selectivity, capture media turntable motor functionality, controller remote start capabilities, control system communication capabilities, and controller enclosure suitability.

### CROSS-REFERENCE TO RELATED APPLICATIONS

This application claims the benefit of the filing date of U.S. Provisional Patent Application No. 61/342,845, filed Apr. 20, 2010, Titled: Versatile Remote Slit Impact Air Sampler Controller System.

### STATEMENT REGARDING FEDERALLY SPONSORED RESEARCH OR DEVELOPMENT

—Not Applicable—

### REFERENCE TO SEQUENCE LISTING, A TABLE, OR A COMPUTER PROGRAM LISTING COMPACT DISK APPENDIX

—Not Applicable—

### BACKGROUND OF THE INVENTION

1. Field of the Invention

The present invention relates in general to an apparatus for operative control of remote sampling devices for the recovery and measurement of airborne contamination. In particular, the present invention relates to a versatile slit impact air sampler controller system for versatile operative control of known slit impact sampling devices, designed by one or both of the named inventors of this application, which are commonly employed for use in critical environments such as pharmaceutical, biotech, or medical clean rooms.

2. Description of the Prior Art

There are only two known controller systems for the inventors remote slit impact air sampling devices, this include the remote slit impact air samplers described in U.S. Pat. No. 5,831,182, Remote Sampling Device for Determining Air Borne Bacteria Contamination Levels in Controlled Environments (November 1998), and Single Use Sterile Slit Impact Sampling Cassette with Rotatable Capture Tray, Non-Provisional patent application Ser. No. 12/660,495 (Feb. 25, 2010). The devices will be referred to interchangeably as remote slit samplers throughout the text. Known controllers for these devices include the Model R2SC.28 and Model R2SC.50 controllers marketed by EMTEK, LLC (www.emtekair.com), to be referred to R2SC controller(s) interchangeably throughout the text.

These are both fairly simple controllers with the R2SC.28 offering a 28.3 liter per minute (LPM) sample rate and the R2SC.50 offering a 50 LPM sample rate. Each controller consists of an aluminum enclosure containing a low particulate generating linear 110V/60 Hz AC powered vacuum pump connected to variable area volumetric flowmeter, or rotometer, for flow control, and having an intake connector (barb) on the front panel for connection to the remote slit samplers vacuum receptacle (barb) and a 0.2 micro HEPA filter on the exhaust portion of the pump for substantial particulate control. An electrical connector is located on the front panel of the enclosure that is used to accept one end of a power cable that is connect between the controller and a complimentary electrical connector on the remote slit sampler by which to transfer operative power to the rotational means (electrical drive motors) for the turntable, or capture tray, in the operative base portions of each remote slit sampler. Both the vacuum pump and the electrical connector of the controller are operatively wired to a digital timer with start/stop functionally. The timer may be used to initiate and end sampling cycles by starting and stopping the vacuum pump and initiate and ending the power supply to the electrical drive motors located in the operative bases of the remote slit sampler devices, for operation of the turntable and/or capture trays of the devices.

Slit impact, or slit-to-agar (STA) air samplers have been the most successful types of microbiological air samplers, receiving wide recognition in the field of medicine, research and industry for the analysis of contamination levels of ambient air environments and has been in regular use to determine air quality in a variety of controlled environments for decades for recovering viable and nonviable particulate matter (e.g., bacteria, mold, viruses, viral particulates, spores, chemicals, etc.) from a sampled volume of air. Several models of slit impact samplers have been developed and described over the years. The other known slit impact samplers include, but are not limited to the Fort Detrick Slit Sampler (described in Sampling Microbiological Aerosols, Public Health Monograph No. 60, at 36); the Slit-to-Agar (STA) Air Sampler from Barramundi Corporation of Homosassa, Fla.; the STA 203 and 204 Samplers from New Brunswick Scientific; Casella Slit Sampler (described in Public Health Monograph, No. 60, at 38), the Air Trace® Environmental Slit-to-Agar sampler from Baker, and Biap Slit-to-Agar Air Sampler marketed by Scantago APS of Denmark.

These devices can be very large and heavy, can generate and harbor a substantial particulate load and contaminants (detailed in U.S. Pat. No. 5,831,182), and employ large 150 mm test plates, making them very undesirable for placement and operation within a controlled environment. Several of these devices do purport to include a remote sampling capability. However, this is no more than attaching a piece of tubing, or piping to the sample inlet of the device and running that to the location to be monitored. This is a very poor sampling methodology, as there is substantial loss of viable microorganisms within the tubing, or piping due to desiccation and sidewall forces that occurs within the length of tubing. The inventors known remote slit impact samplers described, place the actual sampling device with required recovery media within the critical environment for recovery of microorganisms at the desired point of testing, while moving the operative control and vacuum and power source out of the critical area to minimize environmental impact.

As stated, there are no other known controller systems that operate the inventors slit impact air samplers described, other than those which have been used to operate the Remote Slit Sampler of U.S. Pat. No. 5,831,182 for the past 15-years, and the Sterile Cassette System, described in Non-Provisional patent application Ser. No. 12/660,495, for just over a year. While the described controllers have proven to be extremely dependable, with units still operating in the field from 15-years ago, they are substantially outdated at this point from a technology, compliance, and industry expectation standpoint. The substantial issues with the current controllers are described further.

The only functional programmability available with the R2SC controllers is that the sampling time can be set (from 00′01″ to 59′59″) on the elapsed sample timer. No other programming capabilities for sampling periods is possible, such as extending the sample period with longer sampling periods and/or delay, hold, resume capabilities. Sampling with each controller is limited to the described flow for each controller (28.3 or 50 LPM), which is set and maintained manually on the units flow regulator (a rotometer), while several known slit impact samplers offer 100 LPM sampling rates. As each of the described controller devices for the inventors remote slit samplers only offer single fixed air sampling rates (one at 28.3 LPM and the other at 50 LPM), this in itself is limiting, as the industry is looking to capture maximum sample volumes of at least one cubic meter of air per test session, on each capture media, or test plate (e.g., nutrient agar), in a minimal period of time. The flow control of the R2SC controllers is manual via a rotometer flow controller, which does not maintain a constant flow due to air pattern fluctuations due to temperature, and pressure changes over time. Automated flow control (e.g., mass flow, or closed loop circuit control) is expected and is the norm within the industry. The R2SC controllers, offer no flow alarm functionality to warn the user if the proper sample flow rate is not maintained at the sampling device and/or through the controller system, which is crucial to assure appropriate sample volume and particulate capture. Aside from starting and stopping the turntable, or media tray drive motors in the sampling devices, the R2SC controllers offer no rotational control of the turntable or capture media tray drive motors (rotational means) in the remote slit sampler devices, and as such, they are limited to a fixed rotational speed (e.g., 1 revolution per hour). This is true no matter what sampling period is set on the sample timer, as only a standard hysteresis, or permanent magnet type motors can be employed in the remote slit impact sampling devices, as remotely operated by the current controllers. The current controller devices only allow for a fixed rotational control speed of the electrical drive motors of one (1) revolution per hour (RPH), which does not correlate well with higher flow rates. It is ideal to use the entire capture media surface upon which to spread out the sample volume. At the current 1 RPH rotation in conjunction with a flow rate of 100 LPM this would only use a small portion of the capture media surface (approximately 17%), and would not spread contaminants across the plate surface sufficiently for enumeration and evaluation. The R2SC controllers offer no data entry, capture, storage, or output capabilities (e.g., via Ethernet, USB, wireless, RS232, printer, or other known output options), as the units do not include a operative control system (e.g., Single Board Computer or SBC), or any other true communication capabilities, which does not allow for appropriate sample data traceability. The R2SC controllers run directly off of 110 V 50 Hz AC power, as is also output to the sampling heads, which is very limiting for its potential use around the world, greatly limiting sales, and also has potential safety concerns for shock hazard from direct AC power. The devices can only operate the remote sampling heads at a distance up to 35 feet from the R2SC controllers, limiting the distance for remotely operating the remote impact sampling devices. The customer may not easily replace the HEPA exhaust filter employed. This minimizes the times the filter may be changed out and also minimizes revenue from replacement filter orders for the manufacturer, or distributors. Neither of the R2SC controllers offers any data capture, or sample run traceability, as the devices do not include any data management, or processing componentry and associated capabilities, as there functionality is limited to a basic AC electrical sample start/stop timer for operative control, in conjunction with. The R2SC controller, although mostly cleanable, does not offer any specific design, or materials for clean room use and protection of the clean room. The R2SC controllers, more specifically the R2SC.50 controller is heavy over 20 LBS in aluminum and 30 pounds in an optional 316 stainless steel option. The rectangular/blocky design of the controller and large size of the controller (approximately: 15″ L×9″ W×8″ H) makes them potentially disruptive to laminar airflow in clean rooms and makes them difficult to transport and position for operation in some instances. The substantial weight and size of the controls is primarily due to the type of vacuum pump employed in these controllers, while being clean room friendly, low particulate generating pumps, are substantial in both size and weight. Additionally, the metal transport handle of the R2S controllers may become uncomfortable in the hand of the transport when transporting the devices over a lengthy distance (e.g., between facilities, or within a facility).

### BRIEF SUMMARY OF THE INVENTION

### Object of the Present Invention

The following describes the versatile remote slit impact air sampler controller of the present invention, which is designed to remotely operate the inventors known remote slit impact samplers described in U.S. Pat. No. 5,831,182, Remote Sampling Device for Determining Air Borne Bacteria Contamination Levels in Controlled Environments (November 1998), and Single Use Sterile Slit Impact Sampling Cassette with Rotatable Capture Tray, Non-Provisional patent application Ser. No. 12/660,495, but with significantly enhanced operative capabilities over current control systems for these devices. Slit impact, or slit-to-agar (STA) air samplers have been the most successful types of microbiological air samplers, receiving wide recognition in the field of medicine, research and industry for the analysis of contamination levels of ambient air environments and have been in regular use to determine air quality in a variety of controlled environments for decades. The versatile controller as described in the following summary will substantially enhance the functionality and capabilities of these devices and increase their desirability in the industry, and additionally lend itself to the operation of other types of remote sampling devices due to it's capabilities. This summary is not intended to be limiting in scope, but includes the primary advantages of the versatile controller.

The device of the present invention includes componentry and system functionality that allows for either short or lengthy qualified sample periods (e.g., from 1 second to 240 minutes), to meet varying sampling requirements, intended to meet the needs of the industry now and in the future; the device offers alarm functionality to assure a proper sampling flow rate is achieved at the remote sampling head, which is required for optimal particulate capture; the device includes delayed and intermittent sampling capabilities to further increase sampling periods with the remote devices, such as when it is desirable to minimize entry into a critical zone; the device allows for use of electrical stepper motors within the remote slit sampling devices and includes operative control of these electrical stepper motors to assure distribution of the sampled air volume evenly over the entire capture media surface, based on the desired sample time, no matter how long (e.g., 240-minutes), or how short (e.g., 1-minute), thus allowing for appropriate capture (e.g., minimizing desiccation of microorganisms that have been captured) easy enumeration of microorganisms, or other particulate matter, that may be impacted on the capture media employed during testing with the remote slit sampling devices; the device displays, maintains and outputs all key sample parameters associated with the sample test run (e.g., time sampled, total sample time, sample volume, sampling device, date sampled, sample site location, etc.); the device allows for entry, maintenance, selection and output of customer sample descriptions; the device allow for the entry, maintenance and selection of numerous specific remote air sampling devices, maintaining key calibration and use information related to that device (e.g., calibration string, device model, date of calibration, calibration due date, flow rate calibrated, tubing length tested, etc.); the device includes and displays use traceability for maintenance/warranty purposes (e.g., total/cumulative hours and/or minutes of use of the device); the device generates, maintains and outputs a unique sample string identifier for each sampling event performed by the device; the device include an on-board thermal label/paper printer for the immediate output of sample run data, for replicate printing of samples, or for reprinting from memory, which may be affixed to, or submitted with the capture media enclosure, sample collection sheets, sample results reports, etc.; the device offer multiple controlled flow rates (e.g., 28.3, 50 and 100 LPM) to meet the needs of the industry for both routine (e.g., using a high sample rate over a short period, 10-minutes), and in-process monitoring (e.g., using a low sample rate during lengthy production operations such as filling operations, sterility testing, surgical procedures, etc., examples: 35-minutes to 24-hours); the device offer a user friendly touch screen interface that allows for the setting of a variety of sampling based options, including current time/date, time/date formats (European/US), sample device selection, unit display selection (e.g., cubic feet, LPM, cubic meters), printer on/off, flow alarms, sample site entry/selection, print from memory options, infrared remote on/off, sample volume, sample time, sample delay, sample hold, sample resume, etc.; the device offers operational control of the aforementioned sampling devices from a significant substantially longer distance than the previous controllers (e.g., 75 feet) that allows the device to be more readily placed well outside of critical controlled environment, such as outside of pharmaceutical fill lines, filling suites, or laminar airflow benches, and production support rooms; the device allows for sample period start, pause, resume and stop capabilities at a distance from the versatile controller itself by means such as infrared remote control, radio frequency remote control, wireless, or communication via Ethernet, USB, or RS232; the device have a visual sampling tracking/completion indicator that may be viewed from a distance; the device is of a small and streamline size and shape as to have minimal disruptive affects on a controlled environment so as not to jeopardize the integrity of that environment; the device enclosure include materials of a quality and surface finish that may be easily and completely sanitized and be impervious to routine chemical disinfection and include materials that employ antimicrobial agents to minimize the potential for the spread or harboring of contaminants; the operation of the device will not impart a significant impact to the environment and shall include an appropriate level of exhaust filtration (e.g., HEPA filter); the form design of the device is aesthetically pleasing for use in a clean environment; the device primary cover be offered in different colors if desirable to allow for customers to color code the devices for specific areas, or types of use; the device include a mounting boot for maintaining the remote slit samplers for ease of storage and transport; the size and weight of the device lends to it's portability; and the device include a extendable/retractable handle with a rubber grasping surface for comfort adding to the ease of transport; and a mounting boot on top of the controller enclosure for transport/storage of a remote slit sampler.

As well as the operation of the known slit impact sampling devices, the controller system may be used in conjunction with other known, or future capture/sampling devices (e.g., microbial sieve samplers), and varying capture medias, of the inventors own design, or by others, to offer an air sampler controller system which may keep up with continual advances in rapid microbial detection and other detection technologies which may benefit from an air sampling capture platform.

### BRIEF DESCRIPTION OF THE SEVERAL VIEWS OF THE DRAWING

The following describes a versatile remote slit impact air sampler controller system for the enhanced remote operation of known remote slit impact microbial air sampling devices. A more complete appreciation of the versatile controller system and many of the attendant advantages thereof will be readily obtained as the same become better understood by reference to the following detailed description when considered in connection with the accompanying drawings, wherein:

FIG. 1 is an isometric view of the versatile controller from, showing the enclosure cover, printer, sampler transport/storage mount, top deck of chassis, electrical and vacuum connectors, retractable/extendable handle, Touch screen/LCD, LCD protective overlay, and IR remote receiver window.

FIG. 2 is an isometric rear view of the versatile controller showing the rear portion of the chassis which maintains the power entry module with power switch, USB module, Ethernet module, cooling fans, power and vacuum connectors for the remote slit samplers, thermal label/paper printer, handle, sampler mounting cup, enclosure cover, and feet.

FIG. 3 is a planner bottom view of the versatile controller showing the bottom of the chassis, filter replacement cover, and support feet.

FIG. 4 is an isometric view of the versatile controller as attached to the operative base of the remote slit sampler, described in Remote Sampling Device for Determining Air Borne Bacteria Contamination Levels in Controlled Environments, of U.S. Pat. No. 5,831,182. The figure includes vacuum tubing and power cable connections.

FIG. 5 is an isometric view of the versatile controller as attached to the operative base of the remote slit sampler described in Single Use Sterile Slit Impact Sampling Cassette with Rotatable Capture Tray, of U.S. patent application Ser. No. 12/660,495. The figure includes vacuum tubing and power cable connections.

FIG. 6 is an isometric view of the controller from the power supply side with the enclosure cover removed showing those components maintained by the chassis. This includes the power supply, power supply terminal block, alarm speaker, blower controller PCB, controller operating system PCB-1, controller operating system PCB-2, Ethernet module, blower connection plumping, mounting bracket, firmware update port, and IR Remote receiver.

FIG. 7 is an isometric view of the controller from the blower side with the enclosure cover removed showing those components maintained by the chassis. This includes the blower motor, blower base, blower and vacuum connector mounting block, exhaust filter, power entry module, unit cooling fan, blower controller PCB, PCB-1, PCB-2, supply, power supply terminal block, alarm, blower controller PCB, Ethernet module, blower connection plumping, mounting bracket, firmware update port, IR Remote receiver, Ground stud, filter access cover, chassis.

FIG. 8 is an interior view of the removed enclosure cover showing the back of the printer, exposing the stock well, controller board, and mounting frame, as well as handle mount.

FIG. 9 is an interior view of the removed enclosure cover showing the IR receiver window, Touch screen controller board mounting bracket, touch screen controller board, LCD mounting bracket, LCD controller board, cover mounting components, cover mounting flange, transport/storage boot mounting recess

FIG. 10 is an isometric view of a controller system depicting extendable handle functionality, as follows:

FIG. 10A depicts a controller system with extendable handle in the retracted state with the handle as in place for unit operation, or storage.

FIG. 10B depicts a controller system with extendable handle in the upright position prior to extension of the handle.

FIG. 10C depicts a controller system with extendable handle in the upright position with the handle fully extended as is desirable for transport of a controller system.

FIG. 11 depicts a controller system with a extendable handle in the upright position with a handle in the fully extended position and a remote slit impact sampler in place in a transport mount as is appropriate for transport of the two devices.

FIG. 12 depicts an example operative flow diagram of the controller system and a remote sampler depicting the flow of communication, data, and air flow through the system.

FIG. 13 depicts multiple views of the controller system's LCD touch screen displays, which work in conjunction with the controller's operating system, as follows:

FIG. 13A depicts an example of a primary run screen for the unit which allows for initiation, hold, and end of sample cycle options, access to setup displays, label feed, and displays set sample run parameters, as well as real time run data, including: date, air sampler type, time, testing state, countdown of the specific state of testing (delay, test, hold), flow rate units, set flow rate, actual flow rate, test volume units, set sample volume, actual sample volume, sample time format, set sample time, elapsed sample time, delay/test/hold settings, and includes a visual run/plate rotation indicator.

FIG. 13B depicts and example of an initial setup display screen which allows the user to select a desired remote air sampler from a list of pre-defined air samplers, that have been calibrated for use with the system, as well as the associated calibration data for the selected air sampler, which is stored in the controller operating system. Additionally, as included on all setup screens depicted (FIGS. 13B, 13C, 13D and 13E) are arrows keys to allow for the user to navigate through the current display options, as well as modify the selected parameter, and keys to allow the user to exit the setup, returning to the primary run display, or move through the additional setup screens. The screen allows for navigation through the current parameters by also simply touch the desired parameter to be modified.

FIG. 13C depicts an example of a second setup display screen which allows for the user to enter (through an alpha numeric keypad) or pick a sample site description, view the type of device that was selected through setup screen 1, set display units, view the sample rate associated with the selected air sampler, set the sample volume, or sample time, set a sample delay, and test/hold periods.

FIG. 13D depicts an example of a third setup screen which allows for the user to set time and date formats, set time and date, set the volume level for the systems alarm speaker, turn on or off the flow alarm, and set the level at which the flow alarm should occur.

FIG. 13E depicts an example of a fourth setup screen which allows for the user to turn on of off the infrared remote (IR) functionality, select a specific IR identification number for that controller (to allow for multiple controllers to be operated by a single IR remote control in the same proximity), turn on or off the units printer used for printing of sample run data at the end of each run, select for the number of replicate labels to be printed if the printer is on, reprint sample run data from the controllers operating system memory by date and time range, or by selected a number of immediately previous samples to be printed, a print key to initiate printing once the selection of labels to be printed has been made, and a clear memory key to allow for the sample run data from the operating systems memory to be cleared.

FIG. 14 is an image of the LCD/Touch Screen Overlay that seals and protects the LCD on the front of the controller enclosure, depicted the area of a company logo and boarder and the clear.

FIG. 15 is a planner view an example Infrared remote (IR remote) showing its key pads as required for remote operation of a controller system, including functionality for the operation of 8 controller systems, offering Start/Pause/Resume/Stop capabilities.

### DETAILED DESCRIPTION OF THE PREFERRED EMBODIMENTS

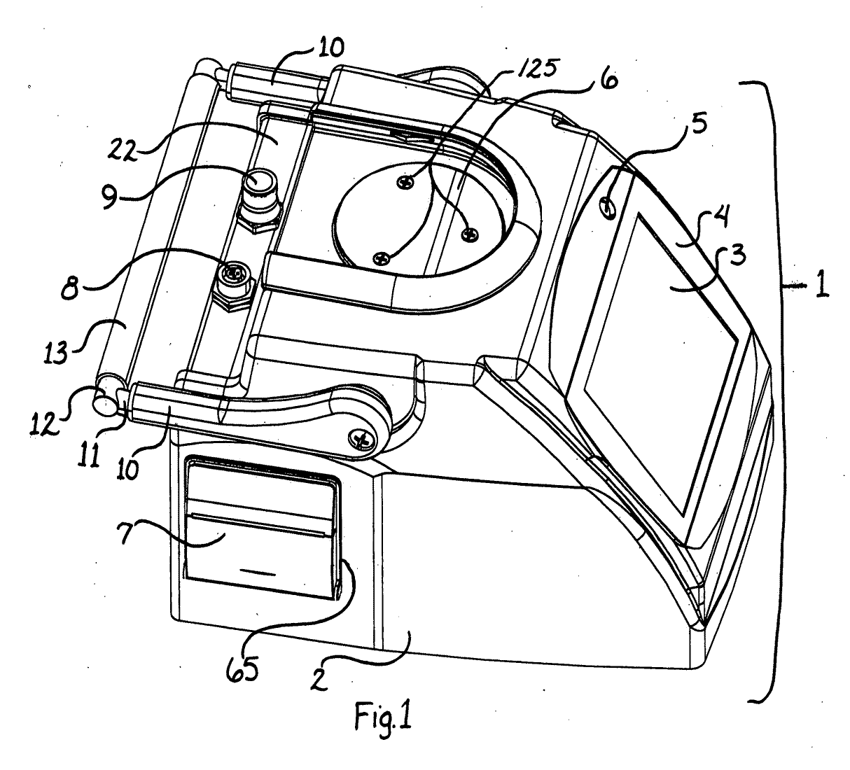

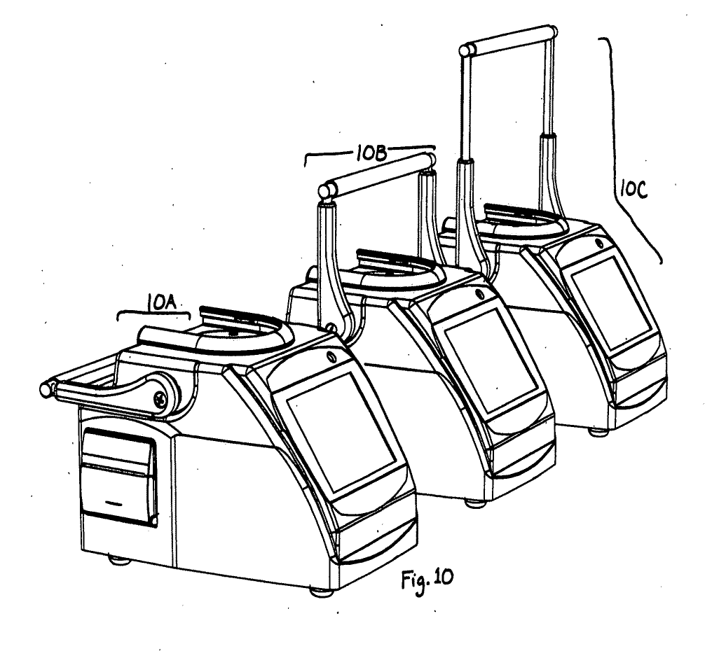

As detailed in FIGS. 1 through 10 a versatile slit impact air sampler controller system (controller), according to the present invention is generally designated by reference numeral 1. Said controller 1 in totality is lightweight and easily portable due to its small size and materials of construction, and employs an easily cleanable enclosure of clean room friendly materials (described further). Said controller 1 is approximately 8 inches at its greatest height, approximately 10 inches in length and 8 inches in width and approximately 12 pounds in weight. The given dimensions, and others to be detailed, are not intended to limit the scope of the controller but are intended to better illustrate the size of the unit when for descriptive purposes to show general scaling of the structures of the device when associated with one another. The preferred embodiments of controller 1 structures, components, and functionality, are described in detail in the following text.

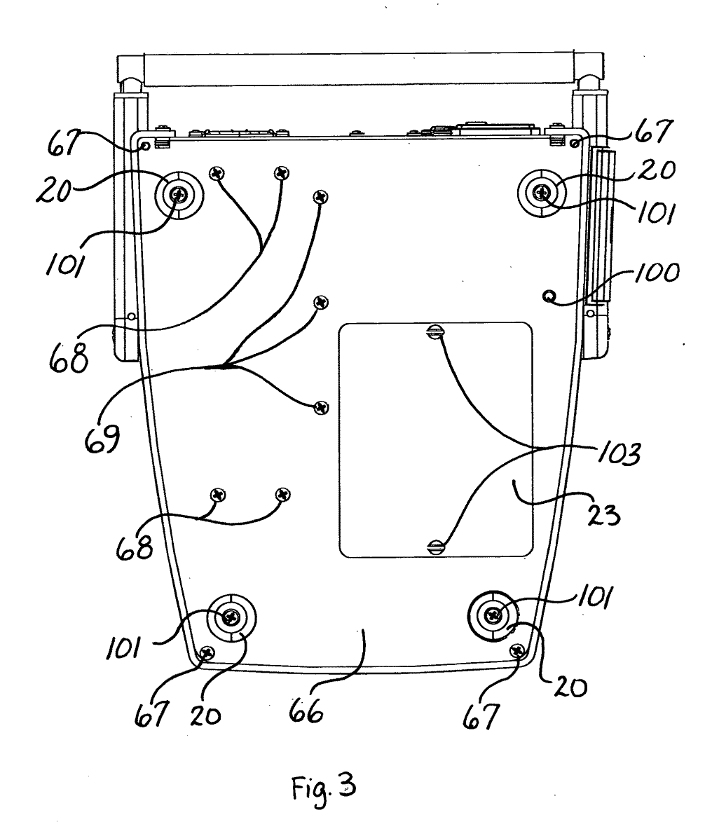

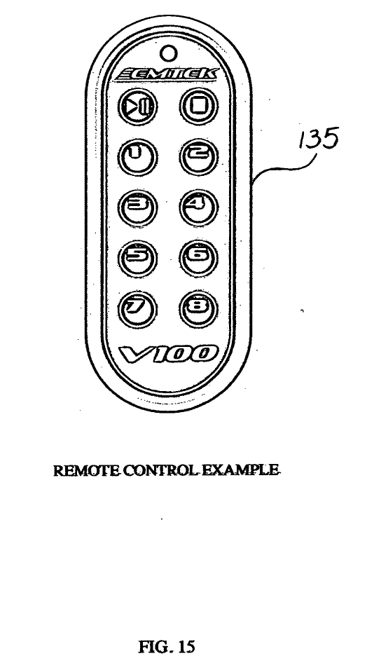

Primary externally viewable components of said controller 1 are best depicted in FIGS. 1, 2, and 3. These include a enclosure cover (or cover) 2, a Liquid Crystal Display/Touch Screen (LCD) 3, a LCD/Touch Screen Overlay (overlay) 4 (FIG. 14), a IR Receiver Window 5, a remote slit sampler mounting boot (boot) 6, a thermal printer (printer) 7, a remote sampler power connector (power connector) 8, a remote sampler vacuum connector (vacuum connector) 9, a handle lower arm 10, a handle shaft 11, a handle 12, a handle wrap 13, a power cord attachment port 14, a power switch 15, a cooling fan 16, a power supply cooling fan 17, a USB port 18, a Ethernet port 19, a chassis rear panel 73, a chassis upper deck 22, and a chassis base 66. As depicted in FIG. 3, the bottom of the chassis includes a filter access plate 23, and support feet 20.

The structure of the enclosure of said controller 1 comprises of two primary components. This includes an enclosure cover 2 that is formed from an integral/single sheet of Kydex™ with Microban™, a plastic, which lays over the second component of the primary structure a chassis 21, formed from a single sheet of 316 Stainless Steel sheet metal. The Kydex™ material of said enclosure cover (cover) 2 contains Microban™, an antimicrobial agent that reduces the growth of microbial contaminants that may come in contact with the surface of the Kydex™ cover material. Said cover 2 is produced in an available Kydex™ color of polar white, as this color is less likely to mask contaminants, soils on its surface, and is aesthetically pleasing for clean room environments, although other colors are possible and may be desirable by a customer to allow the ability to color code the devices for use in a variety of environments, different areas of a facility, or for different sampling usages. Said chassis 21 of the device is intended to create the primary support structure of said controller 1, maintaining said enclosure cover, with its components (to be described further), as well as numerous functional components that are mounted within/upon the chassis itself (to be described further).

As best depicted in FIGS. 1, 2, 4, 5 and 10, said cover 2 of the current embodiment of said cover is thermomolded from a plastic of the name brand Kydex™. Thermomolding is a process that is well known, and as such will not be described in substantial detail. In general it involves heating up a sheet of the Kydex™ material (approximately 0.250″ in thickness, and 2 feet in both length and width), to a malleable temperature and then drawing it over a raised base form (e.g., of wood, or metal) that is created to match and fill the interior dimensions of the cover, while a hollow outer form (e.g., wood, metal) of the exterior dimension of the desired form (the cover) is pressed down over the heated Kydex™ material pressing it over the interior/base form to assure that the material fits tightly over the interior/base form.

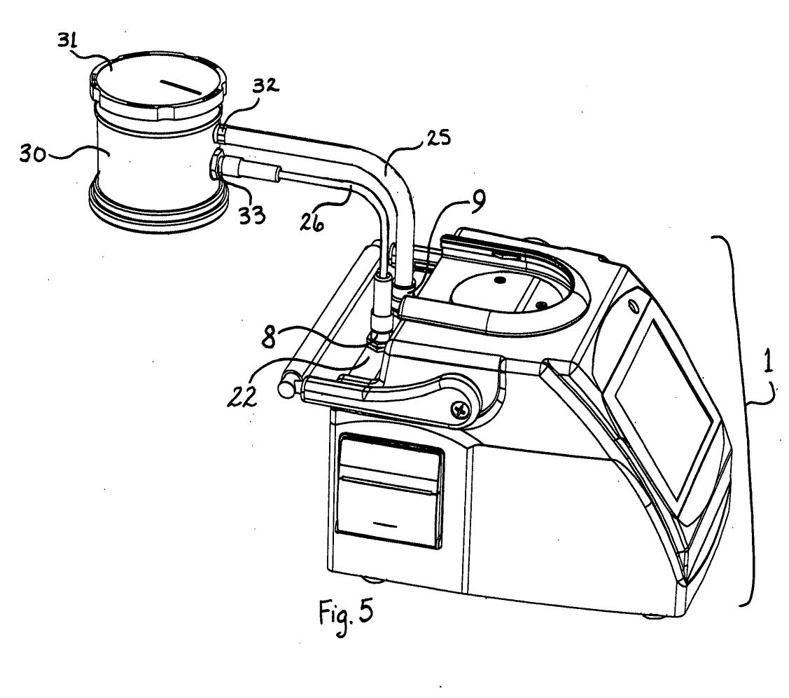

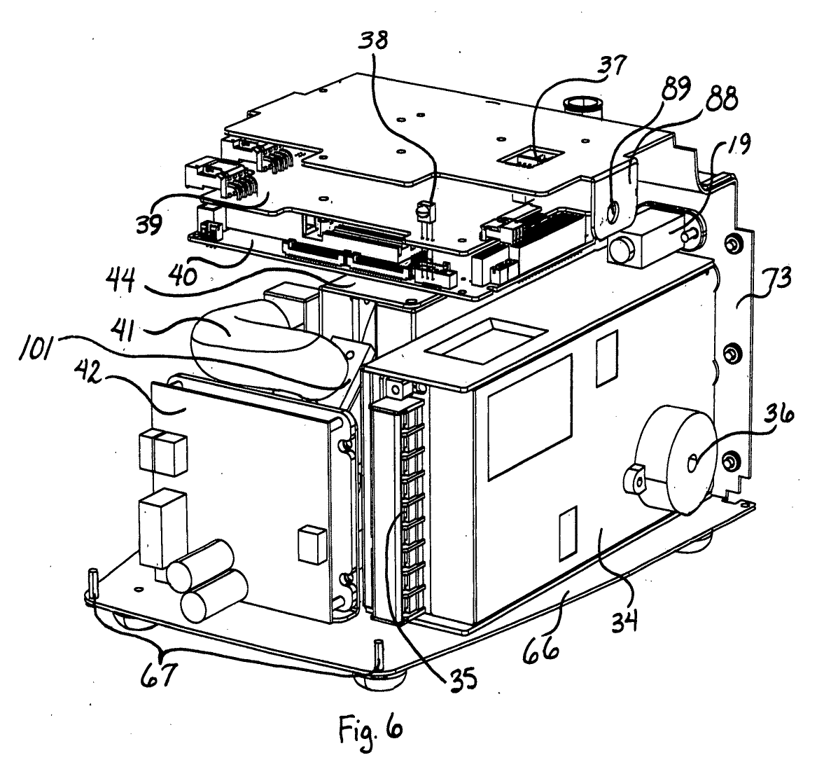

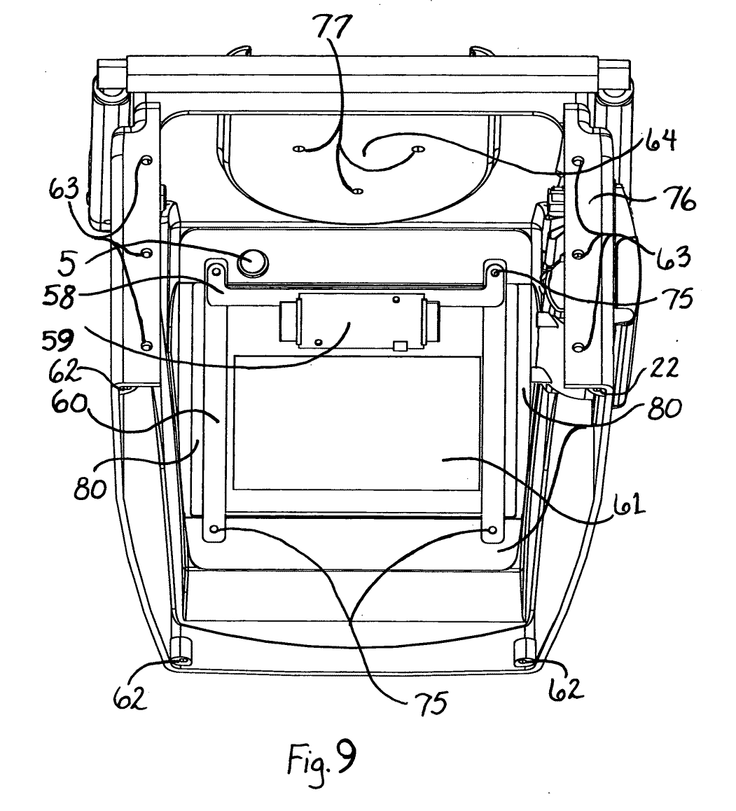

Following thermoforming of said cover, a variety of secondary operations are performed. This includes trimming the margins of the formed material to the desired dimensions; making a cut out (approximately 5″ H×6″ W, not shown), in the approximate front center of the cover for mounting/viewing/operation of said LCD 3; attachment (via hot glue) of four threaded mounting stand-offs (not shown) at four locations 75 (FIG. 9), located on the interior surface of said cover 2 at the interior corner of said LCD/Touch Screen cutout, required for attachment of a set of LCD mounting brackets 60, as well as a touch screen mounting bracket 58 (FIG. 9), for mounting of a touch screen controller 59 (FIG. 9); a small (approximately 0.5″) circular cut out 5, in the upper right margin (as view from said cover exterior, FIG. 5) above said LCD 3 cut out, for operative functionality of a IR receiver 38, mounted on PCB-2 39 (FIG. 6); a set of 3 pass through holes 63 in each of two rear cover flanges 76, for mounting of said cover to said chassis 21; a pair of left/right handle mounting screw pass through holes 57, for mounting of handle bases 10; hot glue attachment of a set of four cover tapped mounting stand offs 62, in each corner of the interior of the lower perimeter of said cover for mounting of said cover 2 to said chassis 21; three pass through holes 77 are created in a top deck boot mounting well (well) 64 of said cover 2 to allow for mounting of a mounting boot 6 to chassis 21 using three threaded boot mounting holes 79, located in a chassis PCB mounting deck 78, of said chassis 21. Other means for forming the cover are of course possible such as injection molding, stereolithography, or machining from a block of material. Although these methods include more up front or long term costs for production. Future methods for forming the case may add additional options for its manufacture.

The one piece integral design of said cover 2 is desirable as it offers substantial protection to the interior components of said controller from environmental factors (e.g., particulates, moisture, etc.), and includes no unsealed openings in said covers top or side surfaces which would allow contaminant ingress. But, said cover is also design with both cleanability, functionality, and visual aesthetics in mind. Said cover 2 is designed and manufactured with tapering lines, rounded corners (for easy cleaning), and a sloped front surface to allow for easy viewing and operation of said LCD 3 (to be described further). The open back portion of the cover, between said rear cover flanges 76, is designed as such to allow for exposure of said chassis rear panel 73, of a chassis 21 for mounting and access ports of key components, and for cooling fan openings, all of which are more properly mounted upon the more substantial 316 Stainless Steel structure of said chassis 21, than said cover 2.

As best depicted in FIGS. 1, 2, 8 and 9, key components mounted to, or upon the surface of said cover 2 includes said LCD 3, which in the current embodiment incorporates a Kyocera 5.1″ TFT color LCD display with integrated touch screen (LCD), said touch screen controller 59, a LCD seal 80, said printer 7, a thermal label/paper printer, a printer mounting bracket 56, a sampler transport/storage boot (boot) 6, and a LCD/touch screen overlay (LCD overlay) 4. Said LCD 3 is mounted within the previously described opening created through the front surface of said cover 2 via a pair of LCD mounting brackets 60 from the under side of said cover using screws passing through the ends of said LCD mounting brackets 60 into described mounting structures affixed to the interior of said cover at said locations 75, that will align said LCD 3 within the LCD opening in said cover 2. Said LCD mounting brackets 60 are formed from 6061 T6 grade aluminum of 0.125″ thickness of a length that extends just beyond the perimeter frame of said LCD having through holes in each end of said LCD mounting brackets 60 to allow for attachment to the cover with screws passing through said bracket openings threading into the described bracket mounting structures. A touch screen controller mounting bracket (controller bracket) 58, is also attached to the upper mounting locations 75 along with the LCD mounting brackets 60. A touch screen controller 59 is then affixed with two-sided tape and small mounting screws to said touch screen controller bracket 58. After the LCD is mounted to the interior of the cover, said seal 80 is glued (silicon sealant, or other non-permanent adhesive) in place to the interior surface of the cover surrounding said LCD 3, immediately around the perimeter margin of the LCD, as it is utilized to minimize particulate movement from the interior of said enclosure cover 2 to the top display surface of said LCD 3, between it and said LCD 3. Said seal is formed (cut) from a sheet of silicone rubber, but could be formed from other materials that would offer characteristics of flexibility, low particulate shedding, closed cell, and temperature and chemical resistance.

As best depicted in FIG. 3 and FIG. 14, from the exterior front surface of said cover 2, said LCD overlay 4 are placed over the touch screen. Said LCD overlay 4 is manufactured from a thin sheet of polycarbonate material, which was chosen for it's chemical resistance properties, flexibility, and wear resistance, but other appropriate materials could be employed for this feature. The backside of said LCD overlay 4 includes an adhesive margin, which is affixed to the external top/front of said cover 2 around the LCD opening, as well as the frame of said LCD 3. The portion of said LCD overlay 4 that resides over the screen portion of said LCD 3 has no adhesive. The combination of said LCD seal 80 from the underside of said cover 2 and said LCD overlay 4 from the top surface of said cover 2 is intended to substantially seal said LCD from environmental contaminants and moisture, protecting said LCD 3 from damage and to maintain screen appearance and function. Said LCD overlay 4 includes a colored margin with company logo, which acts to hide the edges of the touch screen display creating a clean and aesthetic, integrated appearance to said LCD 3 within said controller 1. The portion of said LCD overlay 4 over said LCD 3 screen area, as well as a small circular window which resides in the top margin of the border over said circular IR cut out 5 over a IR remote receiver 38 (FIG. 6) are both clear to allow viewing of the display and for IR remote functionality.

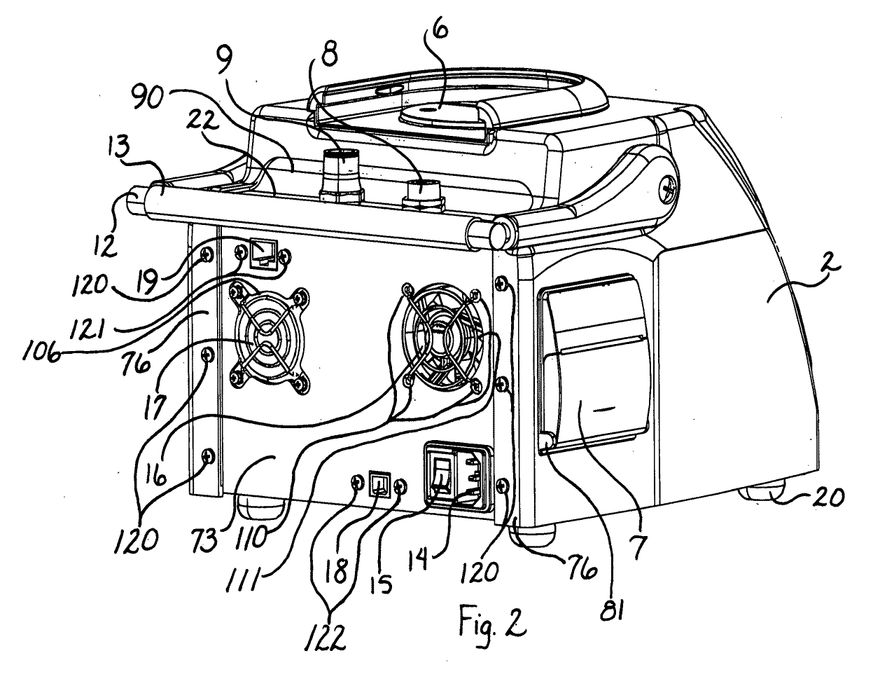

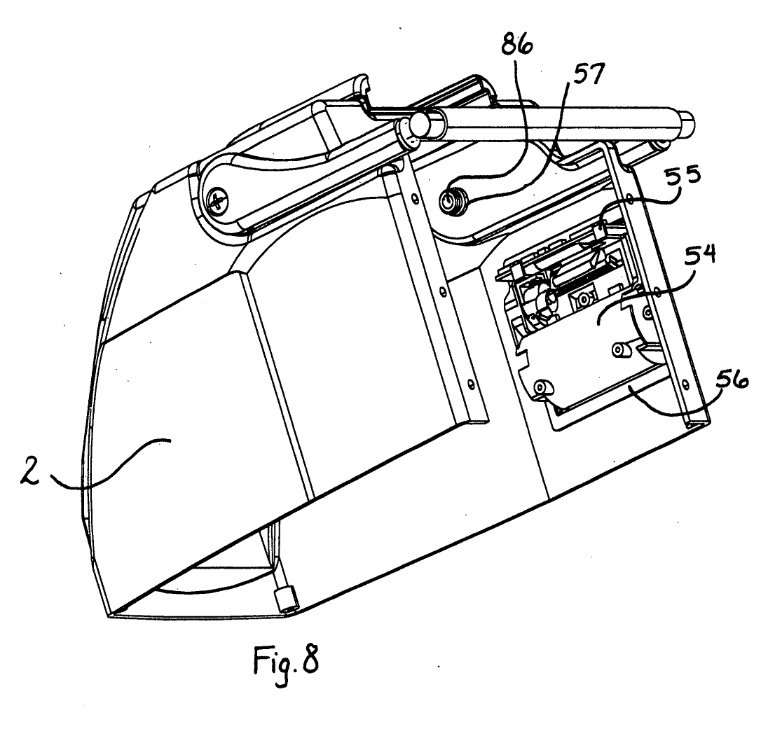

As best depicted in FIGS. 2 and 8, said printer 7, a self contained point of service (POS), “clam shell” style printer (POS printers that contain a integrated label/paper stock well and well/component cover) is mounted within said cover on the left right side of said cover 2, as facing from the front of said controller 1. Said printer 7 is an APS brand EPM203-MRS WHITE-E thermal label/paper printer, of white color. The printer is placed in from the exterior surface of said cover through an opening in said cover that is just large enough to accept the rear portion of the printer comprised of a printer PCB 55 and a label/paper stock well 54, but is small enough to keep a retention frame 81 (FIG. 2) of the front portion of said printer 7, and a printer mounting seal 65 (FIG. 1), from passing through the cover. Said printer mounting bracket 56, fits over the perimeter of the rear of the printer and is affixed to the front portion of said printer 7, with two screws passing through holes in said retention frame 56 (not shown), and through said cover 2, securely clamping it to said seal 65, and to the left rear side of said cover 2. Said printer mounting seal 65 is intended to reduce the chance of liquid, or particulate ingress into the interior of said enclosure cover 2. There are of course other POS printer options, which may include different models/brands of printers (e.g., “clam shell” style, or print head only options), including those that are not “self contained” POS printers. But, the printer chosen had proven to be the most appropriate from a group of printers from three manufacturers and 7 models of printers evaluated for function, fit, operation, and aesthetic. Said seal 65 is formed from a 0.125″ sheet of white silicone rubber, although other appropriate sealing materials and thicknesses may be used, as long as it meets the intended purpose to seal the printer to the case and be aesthetically pleasing (e.g., white to match said cover). The printer is capable of printing on both label and paper stock. The printer outputs a key subset of the defined sample parameter data following each run (if desired). The label stock option allows the user to affix the captured sampler parameter run data to the exterior of the desired capture media for optimal sample data traceability when the sample is processed. Through the set up menu, the user can output duplicate labels from sample data in the buffer, based on a user entered date and time range, or based on a number of samples to be printed, and the user may request replicate labels be printed at the end of each run, select the paper or label output option, and turn on/off the printer function.

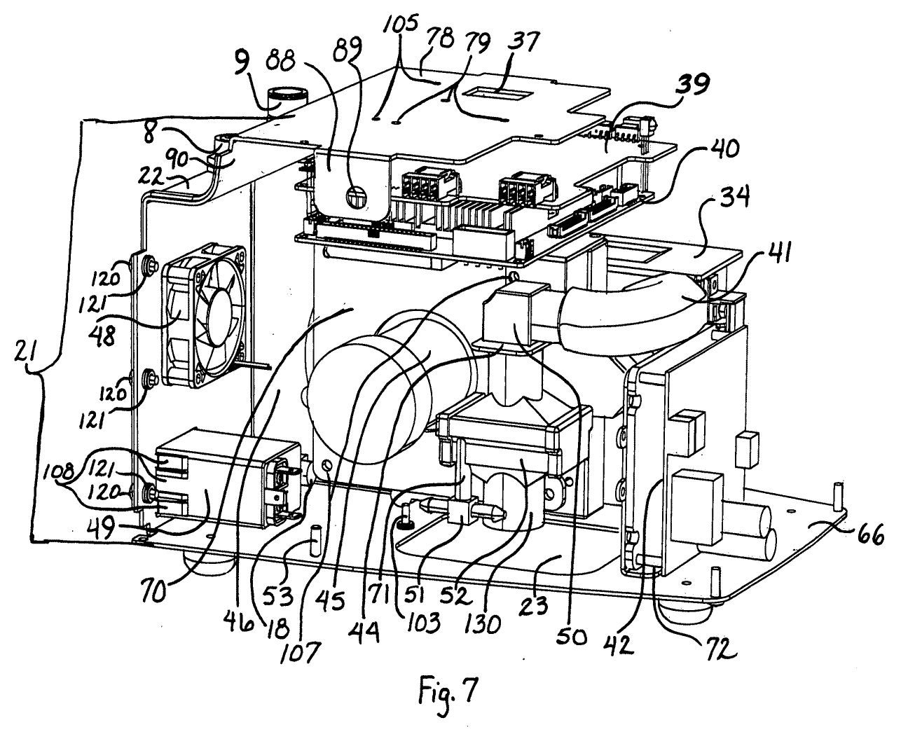

As best depicted in FIGS. 6 and 7, said chassis of the current embodiment is currently formed from a flat sheet of stainless steel of approximately 0.62″ thickness, 9″ in width, and 26″ in length. As flat stock the required external dimensions cuts are made (e.g., by metal shears, and/or laser cutters), as well as second operation in the material to allow for mounting of key components (e.g., pass through holes, threaded holes, PEM nuts, etc.) including said cover 2, a power supply 34, a blower base 46, a blower controller board 42, a PCB-1 40, and PCB-2 39, a power entry module 49, a cooling fan 48, a USB connector 18, and Ethernet module 19, a sampler power connector 8, a blower inlet connector 9, and an extendable handle assembly 85. The material is then bent at the specified locations to form a horizontal chassis base structure (chassis base) 66, of said chassis 21, of approximately 8 inches wide by 10 inches in length, a chassis rear panel 73 of approximately 8 inches in width by 6 inches in height rises vertically at a 90 degree angle from said chassis base 66; a chassis rear deck 22, of approximately 8 inches in width, with a 1 inch ledge width, is formed at the top of said chassis rear panel 73, bending inward horizontally at a 90 degree angle from said chassis rear panel 73; a back wall 90 of said chassis rear deck 22, is formed to rise vertically at 90 degrees approximately 1 inch from said rear deck 22, that leads to a chassis PCB mounting deck (chassis deck) 78 of approximately 6″ in width and 4″ in extension oriented horizontally at 90 degrees from said back wall 90 towards the front of said chassis 21, to reside as suspended approximately 7 inches above said chassis base 66; PCB mounting screw pass through holes 105 are created in said chassis deck 78; a firmware update access port 37 is also located on said chassis PCB mounting deck 78, to allow for cable connectivity to the control systems firmware access/update connector (not shown), on said PCB-2 39. The overall dimensions of said chassis 21 structures are designed for an appropriate tight fit within said cover 2 when all components are mounted upon/within said cover 2 and said chassis 21 when said cover 2 is put in place over said chassis 21 structures.

As best depicted on FIG. 3, said chassis base 66, are the locations of mounting screws, as in place in screw pass through or threaded holes at locations for components mounted to said chassis base 66. This includes four cover screws 67, for mounting to said cover 2 at each corner of said chassis base 66 (two pass through locations shown without screws in place); four power supply screws 68, for mounting said power supply 34 depicted in FIG. 6; three blower base assembly screws 69, for mounting said blower base 46, depicted in FIG. 7; four feet screws 101, for said support feet 20; two filter access plate screws 103, for attachment of said filter access plate 23 to said chassis base 66; and a ground stud mounting location 100, for mounting of ground stud 53, depicted in FIG. 7. Depicted on FIG. 2, of said chassis rear panel 73, are the locations of mounting screws, as in place in screw pass through or threaded holes at locations for components mounted to said chassis rear panel 73. This includes 4 fan mounting screws 74, six cover mounting screws 75, two Ethernet module screws 76, and two USB module screws 77. Said power supply 34, cooling fan 17 is physically mounted to said power supply 34, as received.

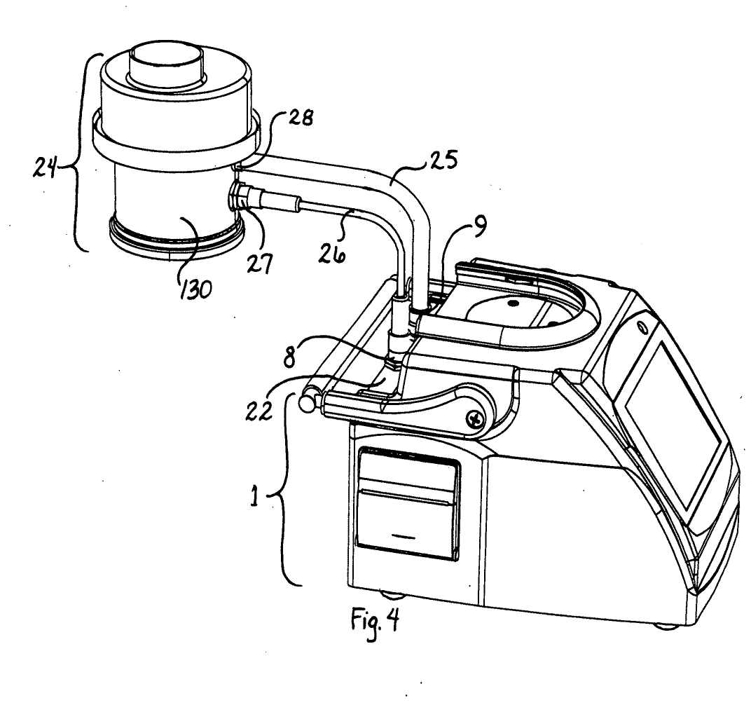

As best depicted in FIGS. 2, 6, and 7, and at locations as previously described, as in depicted in FIGS. 2 and 3 mounted to said chassis are the following components. Beginning with said chassis base said blower control 42 is mounted transversely towards the front of said chassis base 66; said power module 34, is affixed in a position towards the right side of said controller 2, positioned lengthwise on said chassis base 66 both to said chassis base, with a power supply cooling fan 17 positioned in a power supply module fan cut out 106 (FIG. 2); a alarm speaker 36 is mounted, with two side tape, to the outer side of said power supply 34 near the back of said power supply by said rear panel 73; said blower base 46 is attached to said chassis base oriented lengthwise near the centerline of said chassis base 66, to the left side of said power supply 34; said blower 45 is affixed to blower base 46 with the aid of blower mounting plate 70, and mounting screws (not shown), which pass through a set of mounting plate holes 107, which affixes and seals the inlet port (not shown) of said blower 45 to blower base 46. Filter mount bracket 44 is affixed to blower base 46, and then the terminal end of said filter elbow 50 is placed within said bracket 44, a blower exhaust tube 41 is then attached to said blower 45 exhaust port 101, and then to said exhaust elbow 50. A HEPA filter 52 is then pressed on to the terminal end of filter elbow 50, which includes two O-Rings on its outer diameter, which allow for a tight fit and seal to the ID of said HEPA filter 52 (a Pall brand BB50T—Gas Filter). Said HEPA Filter 52 is preassembled with said sensor “T” 51 (a hollow “T” shaped 0.125″ ID clear plastic plumbing fitting) being pressed into a filter sensor outlet 71 on the terminal side of filter 52. Ground stud 53 is located on chassis base as well at a location that places it just behind power entry module 49 when it is installed by threading it into said ground stud mounting location 100. Filter access cover 23 is mounted from the bottom of the base cover with screws 103. A controller cooling fan 16 is mounted to the interior of said chassis rear panel with screws 110 positioning said cooling fan 16, in a cooling fan opening 111. Said power entry module 49 is placed into an opening made in the right rear lower corner of said chassis rear panel. This is a press/snap fit as locking tabs 108 on the sides of said power module 49 are present to lock it in place within the sheet metal opening once it is pressed in that prevent it from being removed without said tabs 108 being depressed. Said Ethernet module 19 and USB module 18 are placed in location and mounted at depicted module openings in said chassis rear panel 73 (FIG. 2) with a set of USB module mounting screws 120 and a set of Ethernet module mounting screws 121. Remote slit sampler power connector 8 and vacuum connector 9 are mounted on said chassis rear deck 22 at the locations as best depicted in FIGS. 1 and 2. Said power connector 8 is threaded into mating threads made in a hole made on said chassis rear deck 22, while said vacuum connector 9 passes through a hole made in said chassis rear deck and threads into the top of blower base 46 at an opening in and through the blower base which forms an air flow path, which is functionally sealed to said blower 45, to allow for connection of vacuum tubing (depicted in FIGS. 4 and 5) that runs from the remote slit samplers (or other), through said vacuum connector, and into blower 45.

Once said cover 2 and chassis 21 are assembled with described components, and all required electrical and plumbing connections are made (e.g., power supply 34 to power entry module 49, USB 18 and Ethernet 19 to PCB-1 40, printer 7 to PCB-1 40, LCD 3 to PCB-1 40, sensor “T” 51 barbs to flow sensor (connection tubing and flow sensor not shown) on PCB-2 39, cooling fan to power entry module 49, PCB-2 39 to PCB-1 40, etc.), the cover is put in place over said chassis and six screws 120 are placed through cover rear flange 76 pass through holes 63 and attached to said chassis rear panel 73 to six matching PEM nuts 121 mounted to said chassis rear panel 73. The cover is also attached with said screws 67, affixing them to tapped cover mounts 62. Then two other components are put into place. A mounting boot 6 resides upon said cover 2 in a boot well 64 (FIG. 9), but it is secured to said chassis PCB mounting deck 78 (FIG. 7), of said chassis 21, with 3 screws 125 passing through holes in boot 6 and pass through holes 77 in said boot well 64 (FIG. 9), mounting to matching threaded holes 79 in said chassis PCB mounting deck 78 (FIG. 78). A transport handle assembly 85 (FIG. 11), comprised of a set of left/right handle bases 10, a set of left/right handle extensions 11, a handle 12, a handle extension bushing 87, handle extension stops (not shown, but reside on the end of handle extensions 11, within the hollow tube interior of handle bases 10, prevent the handle extensions from pulling out of said left/right handle bases 10, past handle extension bushings 87, and provide for an easy extension/retraction of the handle extensions within said handle bases 10), and a handle cover 13, is assembled and mounted over the handle with a set of left/right mounting screws 86 which pass through said left/right cover handle screw pass through holes 57, and attach to said chassis at chassis left/right hole locations 89 (either with threaded holes, or mounting PEM nuts affixed to the surface at the hole location), located on a pair of left/right handle mounting flanges 88 (FIGS. 6 and 7).

In regards to functional components, a variety of options are of course available from which to select power supplies, touch screen controllers, touch screens, LCDs, CPU's, memory cards, PCB boards, printers, vacuum sources (blower, vacuum pumps), power entry modules, electrical connectors, vacuum connectors, wires, stepper motors, etc. As such, the device is not limited to specific sources or models. Other component choices are possible, as long as the chosen components are compatible and properly integrated and offer the desired capabilities, functionality, and aesthetics. Those depicted, or briefly described are those employed in the current embodiment, but other configurations of the components may be employed, or desirable. The enclosure components may be constructed from other known materials. For example the enclosure cover may be created by a variety, or combination of forming processes including injection molding, stereo lithography, thermo-molding, or vacuum-forming, in conjunction with secondary machining operations if required, or could be machined completely from stock materials. It may also be formed from other plastic type materials such as ABS™, Delrin™, polycarbonate (or Lexan™), polyethylene, or others, or it may be formed out of stainless steel, aluminum, or other metals, or other materials. The chassis may be formed of other materials other than 316 Stainless steel, but it should be of sufficient structure to maintain the contained and support componentry. The materials of construction for secondary mounting structures may also be altered. Although, the materials of choice for all components should also be clean room friendly and should not shed, or harbor substantial particulate matter, or outgas any chemicals that would be of concern in the environment in which they may be employed. Other means currently known, or processes that may be available in the future could be used as well, as long as they meet the desired endpoint for each component.

The materials of construction of both said cover 2 and said chassis 21, that have been selected in the current embodiment, are those that are known to be low or non-particulate shedding, and non-porous, and those that are able to contend with cleaning and disinfecting agents commonly used in clean room environments with minimal long term impact, or degradation to the surfaces of the material. The non-porous finish employed disallows entrapment of particulate matter and allows complete cleaning and sanitization of the surface which may be performed using a variety of disinfectant agents such as quaternary disinfectants, alcohol, bleach, hydrogen peroxide, or other commonly used disinfecting agents. Other materials for the cover or chassis include different plastics (e.g., ABS, Polycarbonate, etc.), metals (e.g., 304, 305, 17-7 and other known forms of stainless steel, titanium, aluminums, alloys, etc.), composite materials, etc., and a variety of finishes could be employed including paints (e.g., powder coated with epoxy, polyester), anodizing of aluminum components, or other known metal treatments (e.g., indite). But, the materials and/or finishes should be low or non-particulate shedding, easily cleanable and impervious to degradation from cleaning and disinfecting agents, as to maintain the integrity of the device and the environment in which the device is employed. For example the enclosure cover may be created by a variety, or combination of forming processes including injection molding, stereo lithography, thermo-molding, or vacuum-forming, in conjunction with secondary machining operations if required, or could be machined completely from stock materials. It may also be formed from other plastic type materials such as ABS™, Dekin™, polycarbonate, polyethylene, or others, or it may be formed out of stainless steel, aluminum, or other metals, or other materials. The chassis may be formed of other materials other than 316 Stainless steel, but it should be of sufficient structure to maintain the contained and support componentry. The materials of construction for secondary mounting structures may also be altered. Although, the materials of choice for all components should also be clean room friendly and should not shed, or harbor substantial particulate matter, or outgas any chemicals that would be of concern in the environment in which they may be employed. Other means currently known, or processes that may be available in the future could be used as well, as long as they meet the desired endpoint for each component.

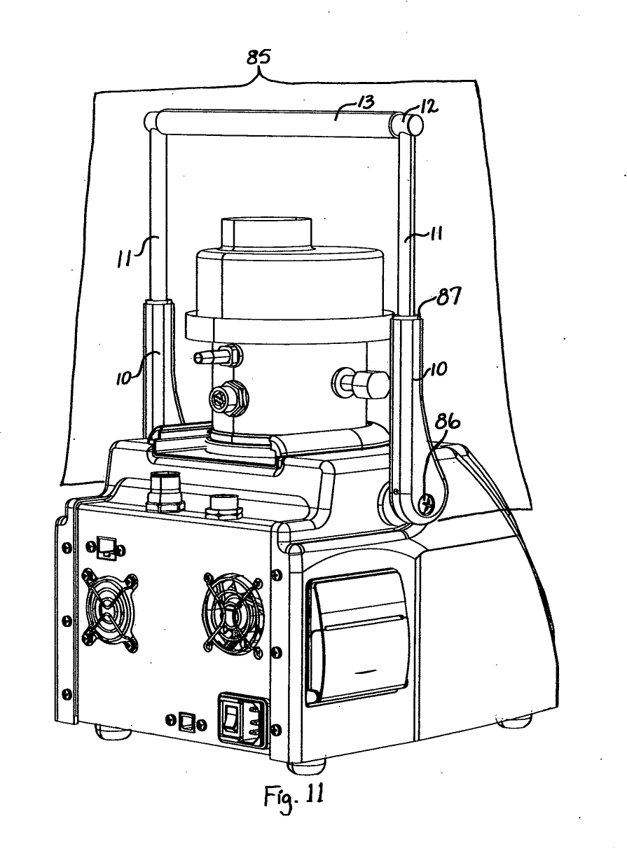

Not depicted in FIGS. 6, 7, 8, 9 are the connectivity between the different components, as with the other components, numerous configurations are possible. As depicted in FIG. 12 the flow of power, air, and data through the system is depicted as within a general flow diagram format. In general, AC power is supplied to said power entry module 49, via a primary AC power cord (patch cord—not shown) attached to a AC power cord attachment port 14, and then attached (plugged into) an appropriate AC power outlet/source (of 85-250AC and 40-60 Hz), and a power on/off switch 15 is switched to the “-” (line power on) position. The circuit is grounded within the unit to the chassis at said ground stud 53, and the input power is connected to said power supply 34 at power supply terminal block 35, which may accept power input may be in the range of 85V 40 Hz to 250V 60 Hz, converting it to a DC output voltage required by all said controller system components. The power is directly supplied from said power supply 34 to the power input module of said PCB-2 39, said blower controller board 42, and said controller cooling fan (cooling fan) 16. Both data and power are transferred between said PCB-1 40 and a PCB-2 39. PCB-1 40 includes the control systems Single Board Computer or SBC, as well as system connectivity for USB, RS232, and Ethernet options. Said PCB-2 39 includes system firmware and hardware for both flow and stepper motor control (A Honeywell Model 3300 flow sensor and custom stepper motor controller (not depicted) are included on said PCB-2 39). In conjunction with the systems overall operating system software and firmware, operative control of the systems flow control and stepper motor controller for remote sampling devices depicted in FIG. 4 a remote slit impact sampler 24 and FIG. 5 a sterile cassette system 30/31. Said PCB-2 39 also supplies power and communication with a touch screen controller 59, in turn said touch screen controller 59 accepts input from the touch screen input overlay, which resides over a LCD 3 display. Said PCB-1 40 supplies data and power to a LCD PCB 61, which is attached to the back of said LCD 3. Said PCB-1 40 supplies power and data to said printer PCB 55, which supplies power and data to said printer 7, print head mechanism (not shown), which then outputs the data to the labels loaded within a paper/label roll compartment 54. Said PCB-1 40 contains a 1 GB SD memory card which maintains all sample run data parameter, which is stored until the memory is full, or the user clears the memory buffer. This data may be viewed through an Ethernet connection to said PCB-1 40 via a web browser or through command line prompts on a personal computer. Said PCB-2 39 supplies stepper motor control in the form of specific voltage outputs to drive a stepper motor contained within each of the two sampling devices depicted in FIGS. 4 and 5 during operation. Based on the selection of a specific sample time, or sample volume on the units set up screens, the system computes and then outputs the proper voltage pulses to the stepper motor to complete an approximately 355 degree rotation of the stepper motor output shaft in the remote sampling devices described.

As best depicted in FIGS. 4, 5 and 7, during operation of said controller 1, air is drawn into a remote sampling device through its air inlet (e.g., a slit shaped inlet). The air flow is then drawn through the remote sampler and then into the vacuum tubing that connects the remote sampler to said controller 21, at a vacuum connector 9. Vacuum connector 9 is in turn attached to an airflow pathway of a blower base 46, which in turn is functionally plumbed to the inlet of a blower 45. The air that is drawn in to the blower is then exhausted through blower exhaust tube 41, flowing through an exhaust elbow 50, and then into exhaust filter 52. A slipstream sample “T” fitting 51 is then plumbed to the described flow sensor on said PCB-2 39. The flow sensor and its associated circuitry, and software, continuously detect, count, and outputs the flow sensor reading obtained from a slipstream sample off of a blower 45 exhaust air output. Said system firmware and software relate the output signal from the sensor to a power voltage output from said PCB-2 39 to a blower controller board 42, which in turns outputs the appropriate voltage to said blower 45, which is associated to a calibrated value obtained the desired sample rate (e.g. 28.3, 50, or 100 LPM) for the sample cycle under way.

In its current embodiment, the versatile controller includes a substantial vacuum source, a roots blower device (model 150193-00), said blower 45, and associated operative-controller board (Ametek Corp. Model 48410-01), said blower controller 42, available from Ametek Corp. that is capable of supplying the required vacuum to the remote slit samplers at a distance of up to 75-feet from the controller, dependent on the flow rate chosen, through supplied vacuum tubing. The lower the flow rate the farther the air sampler may be operated from the controller. For example, this includes the following approximate remote distances of operation for a single remote slit sampler: 75-Feet @ 28.3 LPM, 65 Feet @ 50 LPM and 20 Feet @ 100 LPM. For vacuum supply, the remote slit sampling devices are attached to the controller through a length of half inch diameter flexible vacuum tubing, which attaches to the vacuum receptacle (barb or other receptacle) on the air sampler and then to said vacuum connector 9 on said rear deck 22 of said chassis 21. In other embodiments, a larger diameter flow path may be employed through the system (larger ID tubing, connectors, and blower base flow path) would allow for even greater distances of operation of the remote slit samplers (or other) from said controller and the vacuum source.

The inlet port (not shown) of blower 45 is mounted to blower base 46. The inlet port is approximately 0.7 inches in interior diameter (ID), 1 inches in outer diameter (OD) and 0.25 inches in height. It is mounted and sealed to blower base 46, with blower mounting plate 70, with the inlet port placed and sealed into a complimentary opening in the side of blower base 46. Blower base 46 is approximately 1 inch in thickness and 0.5 inches in height and length and is formed from Delrin™, although many other materials may be used for construction of this component. A flow path has been made internally within the block, approximately 0.5 inches in ID, from the mating opening to blower inlet 45, to the top upper corner surface of blower block 46 where it opens and has been threaded to accepted vacuum connector 9, for operative connection of the blower to the remote sampler. The outlet of blower 45 is functionally attached with vacuum tubing to filter elbow 50, maintained in elbow mount 44, which is attached to blower base 46 which is then attached to exhaust filter 52. Flow control sensor attachment “T” 51, is affixed to filter sensor outlet 71. As previously described the entire assembly is mounted to the top said chassis base 66 with said three blower base mounting screws 69, affixed from the bottom of said chassis base 66. The blower controller board 42 is also mounted to the chassis with a blower board mount 72, which is spot welded to said chassis base 66.

In the current embodiment, the versatile controller includes a powerful operating system including software, firmware and componentry that allows for the integration and operation of all components to be described. The operating system components include both an off the shelf single board controller, said PCB-1 40, which in general includes a central process unit (CPU), which maintains the primary operating system (Windows CE based), the board also houses the memory card, data connectivity/accessibility ports (Ethernet, USB, RS232), runs said printer 7, and LCD via said LCD controller 61, and maintains the key system operating software. A secondary custom board, said PCB-2 39, in general, includes circuitry and componentry for closed loop control of the sample flow rate, maintains system firmware for blower control set points for flow maintenance and initial blower ramp up, houses the stepper motor controller (to be described further), communicates with said touch screen controller and touch screen, and several other key functions. Multiple interfaces are included which allow for communication between the two boards and thus the control of key components including the onboard printer, blower, LCD, and touch screen. Each of these primary components additionally include their own proprietary controller boards.

The Controller can be operated at multiple, user selectable, operating system controlled sample flow rates for accurate sample volume capture and assessments. In its current design sample flow rates include industry standards of 28.3, 50 and 100 Liters Per Minute (LPM), but obviously others could be employed if desired, within the constraint of the vacuum source, or a different vacuum source may be employed. The flow rate, 100 LPM, allows for the collection of a cubic meter of air in 10-minutes, which is a current norm in a variety of air sampling devices. The sample rate though the system is maintained at the selected flow rate in a stable manner through an onboard flow stability control system. As previously stated, the control system includes a known flow control sensor from Honeywell Corporation and incorporates a slipstream sensing methodology as defined in readily available technical documents from said company. In addition to flow rate stability control, the device also includes functionality to allow for the initial vacuum source ramp up speed based on the length of tubing to be used with the sampling device to quickly accelerate the vacuum source motor to the required speed, before the flow stability control system engages.

As said controller 1 is intended to operate the inventors remote slit samplers at differing flow rates (e.g., 28.3, 50, and 100 LPM) the sample inlet domes of the remote samplers themselves are employed for use with varying dimensions of the sample inlet (e.g., slit inlet) to maintain the same sample pass through velocity and capture velocity on the capture media. For example, a slit width of 0.007″ in conjunction with a slit length of 1.375″ and a sample rate through of 28.3 LPM, or 1 CFM would lend itself to a sample velocity of approximately 72 Meters per second, while a slit width of 0.013″ at the same sample rate (28.3LPM) and length would offer a sample velocity of approximately 40 Meters per second; a slit width of 0.023″ with a slit length of 1.375″ at a sample rate of 50 LPM would offer 40 Meters per second; and a slit width of 0.046″ and length of 1.375″ at a sample rate of 100 LPM would also offer 40 MPS. These are just for illustrative purposes, but intended to show how the ability of the controller to include varying flow rates in conjunction with the remote sampling devices, to allow for the retention of an appropriate capture speed at any of the sample flow rates. It is crucial to employ and maintain an appropriate sample impaction velocity, based on the size and type of the intended particulates of collection. In the preferred embodiment for microbial capture, the air inlets are sized as described for 40 meter per second capture velocities at those flow rate described in the examples above. But, as described, a variety of slit widths and lengths may be employed to optimize viable and non-viable particulate capture at differing flow rates.

As is very unique to said controller 1, the device maintains the required, calibrated, sampling parameters and set points of each air sampling device it may operate, for each sample rate of use, and at each desired length of remote sample tubing at which the device would be operated. A special sampling string is maintained within the units control system, which is associated with these key calibrated use point parameters, and is selectable by the user from the LCD Touch screen interface during sample setup. The sampling string includes the air sampler model, serial number, calibrated flow rate, and tubing length to be used for remote operation (Example: An air sampler model R2S, with a serial number of 12345, calibrated for use at 50 LPM with 15 feet of sample tubing would be reflected by a sample string of: R2S.12345.50.15, with two air sampler serial numbers included in the string if the controller were to be operating two air samplers, R2S.12345.54321.50.15). The number of individual air sampler strings and associated operational parameters stored by the system and available for selection by the user is only limited by the system memory, which is maintained on a removable/replaceable flash memory card. Flow rates are calibrated and set against traceable standards (e.g., NIST) through the use of an external software program and may not be altered through the user interface on the unit.

Where other air sampling devices may have a set point for flow control, they do not take into account the impact of differing tubing lengths that the user may desire. With current devices, the longer the sample tubing the longer it takes for the device to get up to the desired sample rate. To overcome this issue the Controller includes a system set point for the sample tubing length (as reflected in the sampling string) which is tied to a specific voltage output from the power supply to the power input of the vacuum means to assure that the vacuum means is quickly ramped to the required speed to achieve the set flow rate dependent on the defined tubing length. At the point the flow rate approaches the desired flow rate (reflected in the sampling string), the system then moves quickly to achieve and maintain the set point determined for the set flow rate associated with the selected air sampler device string which is achieved and maintained by the flow controller system.

The versatile controller's operating system also supplies power and stepper motor rotational control of the turntable and capture trays of both remote slit impact air samplers. With the use of the control system of the versatile controller, stepper motors may be used within the operative bases of the remote air sampling devices to allow for substantial rotational control. Based on the set sampling period, the turntable, and a test plate located on the turntable, will rotate approximately 355 degrees within the defined sampling period. For example if a 2-minute sample time is set, the turntable will rotate approximately 355 degrees to fully use the capture plate surface, spreading out the capture contaminants, while if a 45-minute sample period is selected, the turntables will also rotate 355 degrees. A 355 degree rotation is desirable as it allows for differentiation of the start and end of the sampling period, adding a 5 degree buffer between the start and end position on the capture media. For operative power supply, the remote slit sampling devices are attached to the controller through a length of small diameter power cable (as depicted in FIGS. 4 and 5) with end fittings which attach to the power receptacles 33 (FIG. 5) and 27 (FIG. 4) on the remote slit samplers and then to said power connector 8 on chassis rear deck 22. Differing rotational speeds are desirable, as an environment with a high density of airborne microorganisms, or other contaminants, may require a higher rotational speed of the capture media, than an environment with fewer contaminants. As stated previously, when the capture media is rotated faster the contaminants that are captured are spread out more evenly over the entire capture media surface as opposed to being captured on top of one another, allowing more accurate enumeration of the contaminants recovered in a highly contaminated area. Said controller 1 offers different rotational speeds by means of altering the cycles of electricity to the stepper motors contained within the base of each of the remote slit sampling devices, as is possible when an electric stepper motor is employed. Whatever the rotational speed, it is preferred that the capture media be exposed for sampling for no more than one full rotation, as the same portion of the test plate should not pass the air inlet more than once for reasons including: over exposure and desiccation of microorganisms, or other particulate matter, which were captured on the test plate during the first exposure; capture of microorganisms or other particulates upon one another making enumeration difficult; and the inability to estimate the recovery time of microorganisms captured as it would not be known at which rotation the microorganisms were recovered. This allows for the determination of the time of recovery of particulates such as bacterial or fungal colony forming units (CFU), captured during the sampling period, and based upon the time recorded for the sample period and the location of the CFU on the test plate. This determination allows the operator to tie the contamination recovery event with operations that may have occurred at the time of the CFU recovery event.

The device in its present form operates from direct attachment to a primary AC power source (outlet), but may be operated on DC power (battery operation) in future versions for additional ease of transport and use. The current device includes known auto-switching power supply from Lambda, said power supply 34 (FIG. 6), which allows for operation of the controller and remote air samplers from a variety of AC power inputs including 100V/50 Hz, 110-120V/60 Hz and 220-240V/50 Hz, which is then converted to DC power for the functional electrical componentry of the controller. The power supply is attached to the controller's power entry module, which includes a standard connector port, which allows for attachment of power cords (patch cord) that will mate with most countries power supplies/outlets. Therefore, allowing for easy adaptation and operation in most countries around the world.

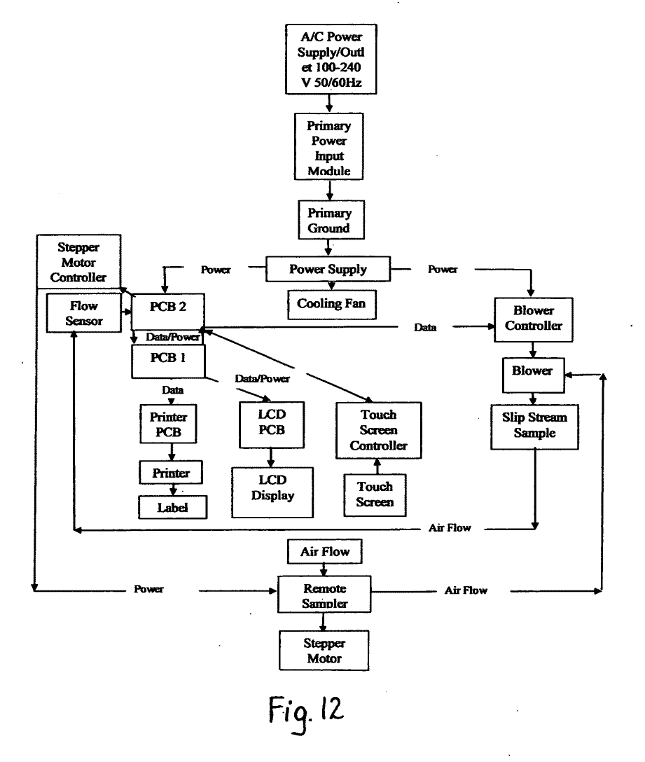

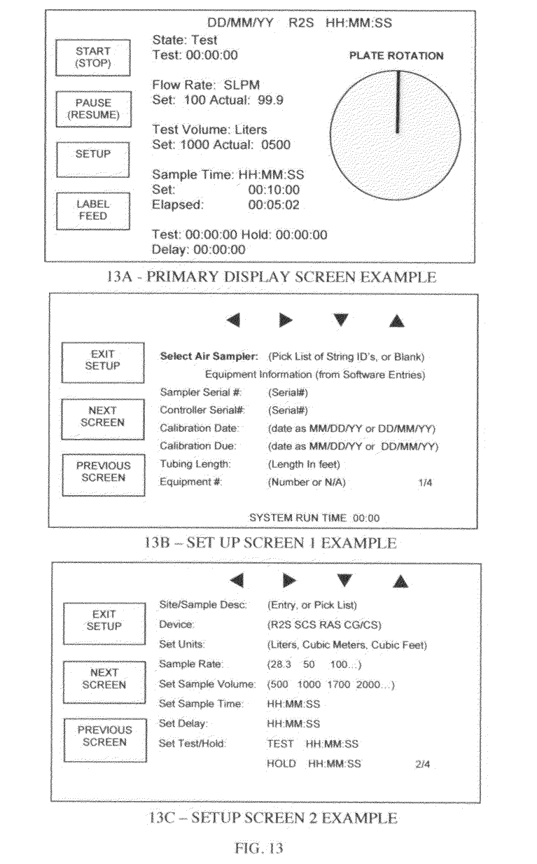

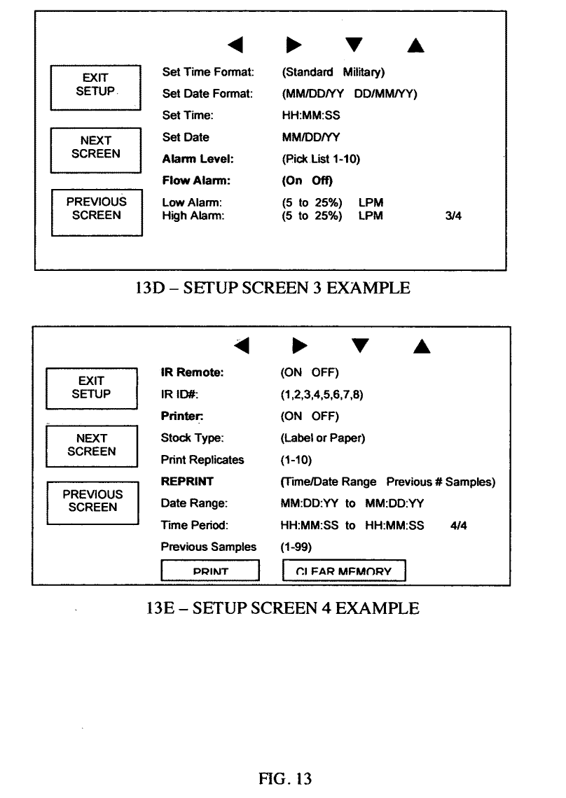

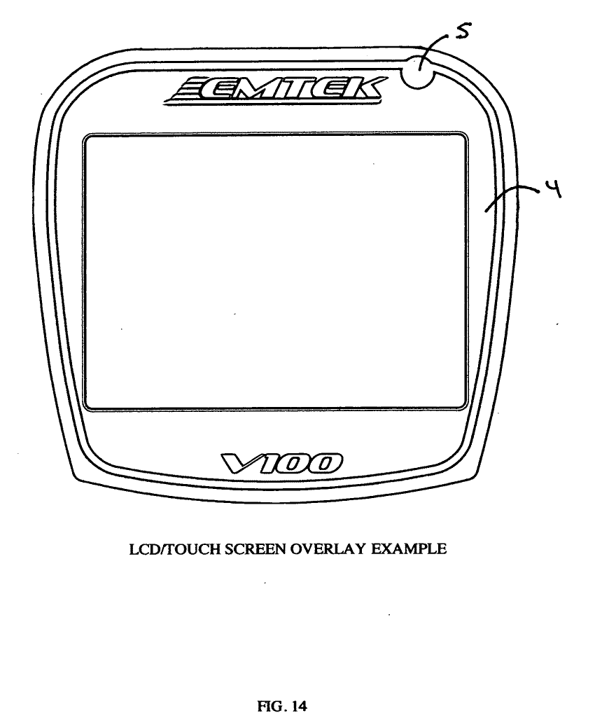

In the current embodiment of said versatile controller 1, the user interfaces with the controller through said LCD 3, a 5.1 inch color display from Kyocera, with a touch screen overlay and touch screen controller board. The operating system in conjunction with a LCD, touch screen and touch screen controller board allow for multiple set up screens, as best depicted in FIG. 13 (13B-13E), for entering user defined sample parameters maintained within the control system, which are dependent on the intended sampling device and type of sampling to be performed and for the initiation and termination of sample runs. The set up screens allow for a selection of a variety of parameters including selection of sampling device (by calibration string), sample volume, sample time, date formats (standard or European), time formats (standard or military), printer on/of, IR on/off, print data from memory options, Display units (Cubic Feet, Liters, or Cubic Meters), and several others options. As depicted in FIG. 13 (13A), during operation said LCD 3 displays key sample information (e.g., time, sampling time, date, sample rate (set and actual), sample volume (cumulative and total), delay/hold/test set and actual values, air sampler type, etc.), as well as a visual sample progress indicator. Obviously other interfaces could be employed to accomplish the desired control aspects for the sampler, such as an LED display with separate push button/key pad switches, or other means. Although, the touch screen interface is likely more intuitive and offers more functional capabilities than other options currently known.

Alarm settings are available for the sample rates, which will produce an audible alarm through said alarm speaker 36, and visual alarm by flashing specific warnings upon said LCD 3, during operation and will then be output the alarm event to the onboard thermal clam shell style printer, mounted on the enclosure of the device. Alarm occurrences are also maintained within the systems internal memory until the memory buffer is cleared, and may be output via said printer 7, or Ethernet by WEB browser, or command line prompt.

In its current embodiment, system software allows for sampling periods of up to 240-minutes may be selected; dependent on the sample flow rate chosen. Although, it is suggested the user validates that sampling periods. In addition, the controller offers the user the capability of entering an initial sample delay, as well as hold and test periods for each sample run. This initial sample delay allows the user time to exit the area to be sampled, while the hold and test period settings allows for intermittent sampling of an area or process for an extended time period, as determine appropriate by the user. For an example, the user may set an initial delay period of 3-minutes and then opt to sample for 5-minute periods with 5-minute hold periods between each 5-minute sampling period, which will occur for a period up to the maximum total sampling period defined for the flow rate chosen. For example if the flow rate chosen is 28.3 LPM and the sampling period is 60-minutes, this would allow for twelve (12) 5-minute test periods, followed by eleven (11) 5-minute hold periods, for a total plate exposure time of 118-minutes (including the 3-minute initial delay). This would result in a total of 60-minutes of active sampling over the 118-minute period. Said blower 45 is turned off during hold periods, as not to capture any particulate matter during the hold periods. If testing for viable microbial organisms is to be performed, it is recommended that only 120-minutes of total plate exposure is employed, but users may qualify other total plate exposure periods if longer hold periods are desired (up to 240-minutes). For non-viable particulate sampling events, longer total exposure periods are possible. Periods of greater than 240-minutes are of course possible and only require fairly simple software modifications.

All sample runs are date and time-stamped and are also assigned a unique sample identification string which is comprised of the units assigned serial number and a non-repeating character string up to 999,999 samples. Each sample may be also be assigned a user defined site identifier/description, which will be output on the printer output, or sample label, or maintained within the system memory with key sample run parameters. An alphanumeric keypad is provided on the touch screen for entering user defined site identifiers/descriptions. But, the site description information may also be created externally and added to the system file from an external computer through an Ethernet connection.

The controller maintains key sample parameter data within its internal memory card, found on said PCB-1 40. The number of samples maintained within the systems internal memory is based upon available memory and can be viewed in a web browser, or may be output in versions to a text or common spreadsheet (or Comma Separated Values, “.CSV”) also through an Ethernet connection, via said Ethernet port 19, to a personal computer using an appropriate command line prompt to access the system files. The data maintained in the system memory includes the remote sampling device model, serial number, set/actual flow rate, set/actual sample volume, sample start/end times, set delay, test and hold period, calibration date and due date of the controller, and alarms during sampling. Each sample may also be assigned a user defined site identifier/description, which will be output on the sample label, and/or maintained within the system memory with key sample run parameters. An alphanumeric keypad is provided on the touch screen for entering user defined site identifiers/descriptions. All sample runs are date and time stamped and are also assigned a unique sample identification string which is comprised of the units assigned serial number and a non-repeating character string up to 999,999 samples. To maintain the integrity of the stored data, it cannot be altered within the system. It may only be output or cleared from the system. Obviously software may be developed to output the sample run data through different means, and in differing format that may integrate with a variety of lab data management systems, or other software packages).

The unit also includes Infrared remote start/stop/pause/resume capabilities, through a separate IR remote 135 (FIG. 15), which works in conjunction with said IR receive 38 mounted on said PCB-2 39 (FIG. 6). Sample runs on said controller 1 can be controller through either said LCD 3 (touch screen) Run Display screen, or the supplied Infrared Remote (IR Remote). From either said LCD display, or the IR Remote, the user may start/stop/pause/resume a sampling session. The IR Remote allows for these functions at a distance of up to 40-Feet, or approximately 12 meters, with line of site to said controller, said IR receiver 37, through said IR receiver window 5, located just above said LCD, on said controller 1. The current IR, remote includes 8-channels of operation, which allows for the operation of up to 8 separate controller units, simply by selecting the IR channel of operation that correlates with the “IR ID#” setting, as depicted on controller setup screen (FIG. 13B). The controller itself can be set to run on a specific channel of operation so multiple devices can be operated with a single remote control, within the same area Obviously a variety of IR remotes could be used with the controller, operating any number of controllers, in conjunction with appropriate software programming of the controllers operating system. Other remote operation capabilities for the controller are possible, which may include Ethernet, USB, and/or RS232 interface with the unit for operation. Other options are possible of course, such as radio frequency (RF), or wireless network control if desired.

For operation of the current embodiment of the versatile remote slit impact air sampler controller, as depicted in FIGS. 4 and 5, said controller 1 is attached to the remote sampling device by a length of a vacuum tubing 25 which is attached to vacuum receptacle 9, on said chassis rear deck 22 of said versatile controller 1, and then to a hose barb 28 (FIG. 4), or 32 (FIG. 5) on the operative base 130 (FIG. 4), or 30 (FIG. 5), of the remote slit impact air sampling device, a proportional length of a power cable 26 (Conxall® wire cable with 4-pin Male/Female MicroMizer™ cable threaded ends) is attached to a mating electrical connector 8 (a ConXall® 4 pin Female connector) on said rear deck 22 of the versatile controller and then a power connector 27 (a ConXall® Female 4-pin connector) (FIG. 4), or 33 (FIG. 5) on the remote air sampling devices depicted. The primary power cord is attached to said power entry module input of the controller and then to an appropriate A/C wall outlet. Said power switch 15, on said chassis rear panel 73, is placed in the line position (“-”), or “turned on”. After said LCD 3 run display screen powers on, the operator may enter said LCD set up screens to select the appropriate sampling device calibration string, as well as confirm, or select all the required sampling parameters, including: sample time, or sample volume, alarm levels, printer on/off, printer stock type (label/paper), IR remote on/off, IR remote channel, etc.

Once the controller is set with the required sampling parameters, the user returns to the run/display screen and the sample cycle on the controller means is initiated via said LCD, or IR remote 135 (FIG. 15). During operation, the versatile controller draws and controls the required volume of air through the air inlet of the remote sampling device, accelerating it to a desired velocity (a combination of sample flow rate from the controller and the open area of the inlet) to insure the proper impingement, or entrainment of particulate matter from the sampled air volume onto, or within the capture media on the turntable, or capture tray rotated beneath the air inlet incorporated within the sample chamber created formed with the mating of the air sampler inlet lid and base structure wherein the capture media resides. The rotational means for the turntable and capture tray are supplied power and controlled by the stepper motor controller system (of said PCB-2 39) of said controller through power cable 26, and rotates the tray/turntable approximately 355 degrees in the set sample time. The sample air volume is then evacuated from the sample chamber of the remote slit sampler through the air outlet of the device and then the sampled air through said hose barb (27 or 33), into and through said vacuum tubing, into said controller vacuum receptacle 9, where the sample volume is drawn through said blower base 46, into said blower 45, through said exhaust port 101, into said tubing 41, then through said elbow 50, into said filter 52, where the air is filter then exhausted substantially though filter exhaust tube 130 controlled, and partially through said filter sensor port 71, where that portion of the air enters said sensor “T” 51, where the air is then directed through 0.125″ ID silicone (or other tubing) to the previously described Honeywell flow sensor, whereby the sensor readings are monitored and the flow rate of said blower 45 is maintained via a closed loop control system of said controllers operating system.

During the run, the controller may be paused if desired and then the sampling may be resumed. If the user does not terminate the sample run manually, the controller system terminates the sampling cycle at the end of the set sampling time, or when the desired volume is achieved. If selected by the user, the printer may then output the sample parameters to label, or paper stock, and maintains the sample run data in the system memory, from which it may be reprinted and/or viewed/accessed via Ethernet access (WEB Browser, or PC command line prompt), until cleared by the user. Upon completion of the test period, the test plate (capture media) is removed (if applicable) from the remote sampling device and the sample run label is affixed to the test plate. For microbial testing, the plate is then incubated for a designated time period (i.e., 3-5 Days) at a specified temperature (i.e., 30-35°). Following the required incubation period, the number of bacterial Colony Forming Units (CFU) are enumerated and the density of air borne bacteria per volume of air tested can then be determined (e.g., CFU/Cubic Foot, CFU/Liter, CFU/Cubic Meter).

### SUMMARY

From the foregoing it will be seen that this invention is one well adapted to attain all ends and objects herein above set forth together with other advantages that are obvious and inherent to the structure and componentry. The described device will substantial enhance the functionality, versatility, and capabilities for the operation of the inventors remote slit sampling devices, moving them to the forefront of air sampling devices. Obviously many modifications and variations of the present invention are possible in light of the above teachings. For example, dimensional changes internally and externally to the controller's enclosure or a different enclosure design, components employed, or component configuration may be acceptable to accommodate alternate components used in additional embodiments of the invention. As such, the described dimensions, structures and components are not intended to be limiting in their scope.

The embodiments of the invention in which an exclusive property or privilege is claimed are defined as follows:

1. A versatile remote slit impact air sampler controller system for the remote operation of known remote slit impact air sampling devices, for the collection of both viable and non-viable particulate matter from ambient air, said device comprising:
a enclosure structure of the device, such as a box, with a enclosed interior and exposed exterior, being comprised of one or more primary structures of materials that are substantial in rigidity as to allow for mounting and support of components contained within or upon said enclosure structure, designed and assembled in a manner to allow for ease of access to the interior components with simple tools, with materials of said enclosure structure being inherently clean room friendly being low particulate shedding, easily cleanable, and substantially impervious to chemical disinfectants, with said enclosure structure being constructed in a manner that will not easily allow for contaminant, or liquid ingress into the enclosure as to disallow for damage of components contained, or supported, by said enclosure structure;
said enclosure structure of the device being of a small and streamline size and shape as to have minimal disruptive affects on a controlled environment so as not to jeopardize the integrity of that environment, while being of an adequate size that may contain and support required components for desired functionality;
said enclosure structure in combination with supported, and contained components of total proportions and weight which lends to the ease of its portability, with said enclosure structure being employed with a handle to allow for ease of transport, with said handle either being fixed in place, moveable, and/or extendable and retractable;
said enclosure structure of the device including a structure on the exterior surface for maintaining a remote sampler during storage and transport, for ease of transport of said remote sampler;
an operative control system housed within said enclosure structure, with said operative control system minimally including a single board controller, but including additional required hardware, software and firmware for the operative control of device components and functions;
a user interface comprised of a visual display including an integrated touch screen and a touch screen controller with said user interface incorporated into said enclosure in a manner that would lend itself to ease of viewing and user interface, with a protective bather in place over said user interface componentry which would substantially seal it to said enclosure structure protecting it and the interior of said enclosure structure from environmental factors; with said user interface functionally wired for communication and power to said operative control system,
said user interface visual and touch screen display including a primary sample run screen for imitating, pausing, resuming, and stopping a sample run, as well as for viewing chosen settings and real time run data;
said user interface visual and touch screen display including one or more set up screens that allows for the user to set a variety of sampling based options, which will be maintained by the system until altered, including, but not limited to: current time/date, time/date formats (European/U.S.), sample device selection, unit display selection for sample rates (liters per minute, cubic feet per minute, cubic meters per minute) and sample volume (e.g., cubic feet, liters, cubic meters), printer on/off, flow alarms, sample site entry/selection, print from memory options, infrared remote on/off, sample volume, sample time, sample delay, sample hold, and sample resume;
a vacuum source housed within and mounted to said enclosure structure directly, or indirectly, and functionally plumbed with a vacuum source inlet fitting to allow for attachment of a length of tubing which may then be attached to a remote sampling device to allow for transfer of air between said remote sampling device and said vacuum source housed in said enclosure structure, with a High Efficiency Particulate Air Filter (HEPA filter) being functionally attached to the terminal end, or exhaust port, of said vacuum source, for purifying the sampled air volume upon exhaust;
said vacuum source having a versatile and high flow rate capability allowing for a range of sample flow rates (e.g., 28.3, 50 and 100 LPM), with a portion of air flow from said vacuum source being functionally plumbed to a flow sensor, with said flow sensor functionally integrated to said operative control system, with said operative control system including a closed loop control system for flow control, with said closed loop control system operatively wired to a vacuum source control system which in turn is operatively wired to said vacuum source, outputting specified voltage to said vacuum source to retain a desired flow rate set point;
a globally functional power supply, housed within and mounted to said enclosure structure, that may accept A/C power in the range of 85-250 Volts and 50-60 Hertz, convert it to DC voltage, and output the required voltage required by the device components, and is functionally wired to a power entry module mounted to said enclosure structure, said power entry module capable of accepting a standard primary A/C power cord female plug attachment with a variety of known A/C male plug ends for attachment to A/C power outlets in countries around the world, to allow for use of the device around the world, with said power entry module including a power off/on switch, with said power supply functionally wired to transfer power to a cooling fan mounted in an exterior side of said enclosure structure to minimize heat build up of components within the enclosure, with said power supply functionally wired to a enclosure structure grounding location, with said power supply functionally wired to said operative control system, and said operative control system in turn functionally wired for supplying power and allowing data transfer to and between said user interface components (visual display controller, touch screen controller), said printer controller, said user interface, said vacuum source controller, and said stepper motor controller for operation and control of these components for air sampling with the device;
a thermal label/paper printer housed within said enclosure structure for the immediate output of sample run data, for replicate printing of samples, or for reprinting from memory, which may be affixed to, or submitted with, the capture media, sample collection sheets, sample results reports, or other data repository, with said thermal printer controller system functionally attached to said operative control system for data and power transfer to said printer;
said operative control system including capabilities for connectivity to external systems to allow for operative control system and data access, via connectivity options including Ethernet, USB, RS232, and wireless;
said operative control system in combination with said user interface including capabilities for selection and performance of short or lengthy sample periods (e.g., from 1-second to 240-minutes);
said operative control system in combination with said user interface including capabilities, which allow for programming and running delayed and intermittent sampling run cycles to further increase sampling periods with the remote devices;
said operative control system including a stepper motor control system to allow for use of electrical stepper motors within the remote sampling devices and includes operative rotational control of those electrical stepper motors to allow distribution of the sampled air volume, and viable and non-viable particulate matter contained within that sampled volume, evenly over a substantial portion of the capture media surface, employed with the remote sampling devices, based on the desired sample time, no matter how long (e.g., 240-minutes), or how short (e.g., 1-minute) the sampling session selected, with communication between said stepper motor controller and said remote sampling device possible via an electrical connector functionally wired to the stepper motor control system, and a electrical connector on the base of the remote sampling device functionally wired to said stepper motor and a removable power cable to allow for connection between the two devices to allow for the transfer of power from the stepper motor controller to said stepper motor in said remote sampler;
said operating control system in combination with said user interface displays, maintains and/or outputs all key sample parameters associated with the sample run, including time sampled, total sample time, sample volume, sampling device, date sampled, sample site location, equipment numbers, equipment calibration information;
said user interface in conjunction with said operating system allows for entry, maintenance, selection and output of custom user sample descriptions;
said user interface in conjunction with said operating system allows for entry, maintenance and selection and operation of multiple remote air sampling devices in combination with the device and associated calibration data;
said operative control system include the capability to maintain key calibration and use information related to that device calibration, including identification string, device model, date of calibration, calibration due date, flow rate calibrated, and tubing length tested;
said operative control system maintains and displays (on said visual display) cumulative hours and minutes of use of the device as required for maintenance/warranty purposes said operative control system generates, maintains, and outputs a unique sample string identifier for each sampling event performed by the device;
said device offers operational control of the aforementioned sampling devices from a significant distance through connected vacuum tubing and stepper motor power cable assemblies that allows the device to be more readily placed well outside of critical controlled environments, such as outside of pharmaceutical fill lines, filling suites, or laminar airflow benches, and production support rooms, to minimize the impact to the environment to be sampled;
said operative control system allows the device to be operated at a distance from the device itself by means such as infrared remote control, radio frequency remote control, wireless, or communication via Ethernet, USB, or RS232;
said user interface includes a visual sampling tracking/completion indicator that may be viewed from a distance;

2. The device of claim 1 as operated in combination with the inventors device of U.S. Pat. No. 5,831,182, Remote Sampling Device for Determining Air Borne Bacteria Contamination Levels in Controlled Environments (November 1998), and

3. The device of claim 1 as operated in combination with the inventor's device of Non-Provisional patent application Ser. No. 12/660,495 (Feb. 25, 2010), Single Use Sterile Slit Impact Sampling Cassette with Rotatable Capture Tray,

4. The device of claim 1 whereby substantial portions of said enclosure structure of the device include structural materials that included integrated antimicrobial minimize the potential for the spread or harboring of contaminants as related to the devices use.

5. The device of claim 1 whereby said enclosure is aesthetically pleasing for use in a clean environment.

6. The device of claim 1 where a portion of said enclosure structure be manufactured in differencing colors as may be desirable to allow for the user to have the ability to color code the devices for specific areas, or types of use.

7. The device of claim 1 operated in combination with currently known, or future remote capture/sampling devices, which may benefit from the combined operation with the device.

8. The device of claim 1 in combination with a software program that allows for calibration of the operative control system of the device in combination with known, or future remote sampling devices at multiple sampling flow rates. Said software program either being contained on a separate system, such as a personal computer, or as incorporated into said operative control system of the device.
